(19) United States
(12) Patent Application Publication
(10) Pub. No.: US 2013/0151118 A1
(43) Pub. Date: Jun. 13, 2013

(54) AIR-FUEL RATIO CONTROL APPARATUS, AND CONTROL METHOD, OF HYBRID POWER UNIT

(71) Applicant: TOYOTA JIDOSHA KABUSHIKI KAISHA, Toyota-Shi (JP)

(72) Inventors: Makoto YAMAZAKI, Gotenba-shi (JP); Hidekazu NAWATA, Susono-shi (JP)

(73) Assignee: TOYOTA JIDOSHA KABUSHIKI KAISHA, Toyota-Shi (JP)

(21) Appl. No.: 13/711,129

(22) Filed: Dec. 11, 2012

(30) Foreign Application Priority Data
Dec. 12, 2011 (JP) 2011-271258

(51) Int. Cl. F02D 43/04

(52) U.S. Cl. CPC F02D 43/04; Y10S 903/905
USPC 701/103; 180/65.28; 903/903

(57) ABSTRACT

The invention relates to an air-fuel ratio control apparatus of a hybrid power unit that selectively executes a first mode in which a ratio of a period during which an internal combustion engine is operated is relatively small, and a second mode in which the ratio of the period during which the internal combustion engine is operated is relatively large. This air-fuel ratio control apparatus executes a target air-fuel ratio correction when a difference among air-fuel ratios in a plurality of combustion chambers exists or is greater than a predetermined difference. An air-fuel ratio correction amount that is a correction amount for the target air-fuel ratio by the target air-fuel ratio correction is set according to whether operational control of the internal combustion engine according to the first mode is being executed or whether operational control of the internal combustion engine according to the second mode is being executed.

### INCORPORATION BY REFERENCE

The disclosure of Japanese Patent Application No. 2011-271258 filed on Dec. 12, 2011 including the specification, drawings and abstract is incorporated herein by reference in its entirety.

### BACKGROUND OF THE INVENTION

1. Field of the Invention

The invention relates to an air-fuel ratio control apparatus, and control method, of a hybrid power unit.

2. Description of the Related Art

Japanese Patent Application Publication No. 2011-51395 (JP 2011-51395 A) describes a hybrid power unit that is provided with an internal combustion engine and an electric motor, and that selectively executes operational control of the internal combustion engine (hereinafter, operational control of the internal combustion engine will be referred to as “engine operation control”) according to a mode in which the ratio of a period during which the internal combustion engine is operated is relatively small (hereinafter, this mode will be referred to as the “CD mode”), and engine operation control according to a mode in which the ratio of the period during which the internal combustion engine is operated is relatively large (hereinafter, this mode will be referred to as the “CS mode”). Also, in an internal combustion engine provided with a plurality of combustion chambers, differences among the air-fuel ratios in the combustion chambers (a so-called air-fuel ratio imbalance) are known to occur.

If there is an air-fuel ratio imbalance, or a relatively large air-fuel ratio imbalance, in the internal combustion engine of the hybrid power unit, the emission characteristic of exhaust gas discharged from the internal combustion engine (hereinafter, this characteristic will be referred to as the “exhaust emission characteristic”) will end up decreasing.

### SUMMARY OF THE INVENTION

The invention thus provides an air-fuel ratio control apparatus, and control method, of a hybrid power unit, capable of maintaining a good exhaust emission characteristic even if there is an air-fuel ratio imbalance, or a relatively large air-fuel ratio imbalance, in the internal combustion engine of the hybrid power unit.

A first aspect of the invention relates to an air-fuel ratio control apparatus of a hybrid power unit provided with an electric motor and an internal combustion engine having a plurality of combustion chambers, that selectively executes operational control of the internal combustion engine according to a first mode in which a ratio of a period during which the internal combustion engine is operated is relatively small, and operational control of the internal combustion engine according to a second mode in which the ratio of the period during which the internal combustion engine is operated is relatively large. This air-fuel ratio control apparatus includes a controller that executes a target air-fuel ratio correction that corrects a target air-fuel ratio when a difference among air-fuel ratios in the combustion chambers exists or is greater than a predetermined difference. The controller also sets an air-fuel ratio correction amount that is a correction amount for the target air-fuel ratio by the target air-fuel ratio correction according to whether operational control of the internal combustion engine according to the first mode is being executed or whether operational control of the internal combustion engine according to the second mode is being executed.

According to this aspect, the effects described below are able to be obtained. That is, with the engine operation control according to the first mode (hereinafter, operational control of the internal combustion engine will be referred to as “engine operation control”), the ratio of the period during which the engine is operated is relatively small, and with the engine operation control according to the second mode, the ratio of the period during which the internal combustion engine is operated is engine relatively large. Therefore, when there is a difference among air-fuel ratios in the combustion chambers or when that difference is greater than a predetermined difference (i.e., when there is an air-fuel ratio imbalance or when there is a relatively large air-fuel ratio imbalance), the correction amount to be added to the target air-fuel ratio in order to keep the exhaust emission characteristic at the desired characteristic (hereinafter, this correction amount will be referred to as the “imbalance air-fuel ratio correction amount”) is naturally different when engine operation control according to the first mode is being executed than it is when engine operation control according to the second mode is being executed, even if the air-fuel ratio imbalance is the same. Therefore, if the imbalance air-fuel ratio correction amount when the engine operation control according to the first mode is being executed and the imbalance air-fuel ratio correction amount when the engine operation control according to the second mode is being executed are set based on the same approach, the exhaust emission characteristic may not come to match the desired characteristic. That is, in order to reliably keep the exhaust emission characteristic at the desired characteristic, when the engine operation control according to the first mode is being executed, the imbalance air-fuel ratio correction amount should be set to an imbalance air-fuel ratio correction amount suitable for this case. Also, when the engine operation control according to the second mode is being executed, the imbalance air-fuel ratio correction amount should be set to an imbalance air-fuel ratio correction amount suitable for this case. Here, in this aspect, the imbalance air-fuel ratio correction amount is set according to whether the engine operation control according to the first mode is being executed or whether the engine operation control according to the second mode is being executed. Therefore, according to this aspect, when the engine operation control according to the first mode is being executed, the imbalance air-fuel ratio correction amount is able to be set to an imbalance air-fuel ratio correction amount that is suitable for this case, and when the engine operation control according to the second mode is being executed, the imbalance air-fuel ratio correction amount is able to be set to an imbalance air-fuel ratio correction amount that is suitable for this case. Therefore, according to this aspect, when there is an air-fuel ratio imbalance or when there is a relatively large air-fuel ratio imbalance, the exhaust emission characteristic is able to be kept at the desired characteristic, regardless of the mode of engine operation control, and as a result, a good exhaust emission characteristic is able to be maintained.

In the aspect described above, the controller may set the air-fuel ratio correction amount to a smaller value as a time elapsed after operation of the internal combustion engine starts becomes longer.

Also, in the air-fuel ratio control apparatus described above, the controller may set the air-fuel ratio correction amount to a smaller value the higher a temperature of the internal combustion engine is.

Also, in the air-fuel ratio control apparatus according to the first aspect described above, the hybrid power unit may also include a battery, and the controller may select the first mode when there is a request to give priority to consuming electric power stored in the battery over ensuring that there be at least a predetermined amount of electric power in the battery, and select the second mode when there is a request to give priority to ensuring that there be at least the predetermined amount of electric power in the battery over consuming electric power stored in the battery.

Alternatively, in the air-fuel ratio control apparatus according to the first aspect described above, the hybrid power unit may also include a battery, and the controller may select the first mode when an amount of electric power stored in the battery is equal to or greater than a predetermined amount, and select the second mode when the amount of electric power stored in the battery is less than the predetermined amount.

In the air-fuel ratio control apparatus described above, the controller may operate the internal combustion engine so as to ensure output power required of the hybrid power unit only when it is not possible to ensure the required output power by output power from the electric motor when the first mode is selected, and operate the internal combustion engine so as to generate electric power to be stored in the battery when the second mode is selected.

A second aspect of the invention relates to an air-fuel ratio control method of a hybrid power unit provided with an electric motor and an internal combustion engine having a plurality of combustion chambers, that selectively executes operational control of the internal combustion engine according to a first mode in which a ratio of a period during which the internal combustion engine is operated is relatively small, and operational control of the internal combustion engine according to a second mode in which the ratio of the period during which the internal combustion engine is operated is relatively large. This air-fuel ratio control method includes executing a target air-fuel ratio correction that corrects a target air-fuel ratio when a difference among air-fuel ratios in the combustion chambers exists or is greater than a predetermined difference, and setting an air-fuel ratio correction amount that is a correction amount for the target air-fuel ratio by the target air-fuel ratio correction according to whether operational control of the internal combustion engine according to the first mode is being executed or whether operational control of the internal combustion engine according to the second mode is being executed.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a view of a vehicle provided with a hybrid power unit that includes an internal combustion engine that has an air-fuel ratio control apparatus according to one example embodiment of the invention;

FIG. 2A is a view showing the relationships among time elapsed after the internal combustion engine is started, a CD mode air-fuel ratio correction amount, and a CS mode air-fuel ratio correction amount;

FIG. 2B is a view showing the relationships among a temperature of the internal combustion engine (or a temperature of coolant that cools the internal combustion engine), the CD mode air-fuel ratio correction amount, and the CS mode air-fuel ratio correction amount;

FIG. 3 is a view illustrating an example of a routine for executing a target air-fuel ratio correction according to the example embodiment;

FIG. 4 is a view of a specific example of the internal combustion engine according to the example embodiment;

FIG. 5 is a graph showing the purification characteristic of a catalyst;

FIG. 6A is a graph showing an output characteristic of an upstream air-fuel ratio sensor;

FIG. 6B is a graph showing an output characteristic of a downstream air-fuel ratio sensor;

FIG. 7A is a graph showing changes in an upstream air-fuel ratio sensor output value when all fuel injection valves are normal;

FIG. 7B is a graph showing changes in the upstream air-fuel ratio sensor output value when there is a problem in which a larger quantity of fuel than a command fuel injection quantity ends up being injected into one combustion chamber; and

FIG. 7C is a graph showing changes in the upstream air-fuel ratio sensor output value when there is a problem in which only a smaller quantity of fuel than the command fuel injection quantity ends up being injected into one combustion chamber.

### DETAILED DESCRIPTION OF EMBODIMENTS

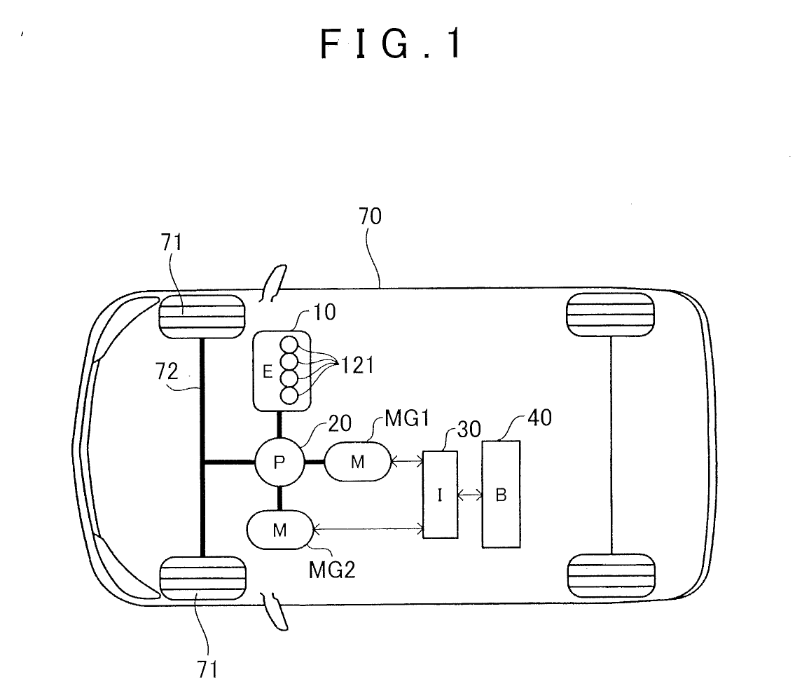

Next, example embodiments of the invention will be described. FIG. 1 is a view of a vehicle provided with a hybrid power unit that includes an internal combustion engine that has an air-fuel ratio control apparatus according to one example embodiment of the invention (hereinafter simply referred to as “this example embodiment”). As shown in FIG. 1, the vehicle 70 is provided with an internal combustion engine 10, a power splitting mechanism 20, an inverter 30, a battery 40, driving wheels 71, a drive shaft 72, a motor-generator (hereinafter this motor-generator will be referred to as a “first motor-generator”) MG1, and another motor-generator (hereinafter this motor-generator will be referred to as a “second motor-generator”) MG2.

The internal combustion engine 10 includes a plurality of combustion chambers (the internal combustion engine shown in FIG. 1 has four combustion chambers) 121. The internal combustion engine 10 is connected to the power splitting mechanism 20. When fuel is combusted in the combustion chambers 121, the internal combustion engine 10 is operated and outputs power to the power splitting mechanism 20. The power splitting mechanism 20 is able to output the power input from the internal combustion engine 10 to one, two, or all of the drive shaft 72, the first motor-generator MG1, and the second motor-generator MG2.

The first motor-generator MG1 is connected to the power splitting mechanism 20, and is also connected to the battery 40 via the inverter 30. When electric power is supplied from the battery 40 to the first motor-generator MG1, the first motor-generator MG1 is driven and outputs power to the power splitting mechanism 20. Therefore at this time, the first motor-generator MG1 operates as an electric motor. Also, the power splitting mechanism 20 is able to output the power input from the first motor-generator MG1 to one, two, or all of the drive shaft 72, the internal combustion engine 10, and the second motor-generator MG2. However, when power is input to the first motor-generator MG1 via the power splitting mechanism 20, the first motor-generator MG1 is driven and generates electric power. Therefore at this time, the second motor-generator MG1 operates as a generator. Also, the electric power generated by the first motor-generator MG1 is stored in the battery 40 via the inverter 30.

The second motor-generator MG2 is connected to the power splitting mechanism 20, and is also connected to the battery 40 via the inverter 30. When electric power is supplied from the battery 40 to the second motor-generator MG2, the second motor-generator MG2 is driven and outputs power to the power splitting mechanism 20. Therefore at this time, the second motor-generator MG2 operates as an electric motor. Also, the power splitting mechanism 20 is able to output the power input from the second motor-generator MG2 to one, two, or all of the drive shaft 72, the internal combustion engine 10, and the first motor-generator MG1. However, when power is input to the second motor-generator MG2 via the power splitting mechanism 20, the second motor-generator MG2 is driven and generates electric power. Therefore at this time, the second motor-generator MG2 operates as a generator. Also, the electric power generated by the second motor-generator MG2 is stored in the battery 40 via the inverter 30.

Also in this example embodiment, two modes of control of the hybrid power unit are provided, i.e., a CD mode and a CS mode. In the CD mode, the ratio of an engine operating period (i.e., a period during which the internal combustion engine is operated) to the total period for which the CD mode is selected is relatively small. On the other hand, in the CS mode, the ratio of the engine operating period to the total period for which the CS mode is selected is relatively large. Also in this example embodiment, either the CD mode or the CS mode is selected depending on certain conditions.

Next, air-fuel ratio control of this example, embodiment will be described. In the description below, an air-fuel ratio refers to the air-fuel ratio of an air-fuel mixture that forms in the combustion chamber, a fuel supply amount refers to the amount of fuel supplied to the combustion chamber, an air supply amount refers to the amount of air supplied to the combustion chamber, an air-fuel ratio imbalance refers to a difference among air-fuel ratios in the combustion chambers, and an exhaust emission characteristic refers to the emission characteristic of exhaust gas.

In this example embodiment, when the air-fuel ratio is greater than a target air-fuel ratio (i.e., when the air-fuel ratio is leaner than the target air-fuel ratio), the air-fuel ratio is controlled so as to become smaller toward the target air-fuel ratio. On the other hand, when the air-fuel ratio is smaller than the target air-fuel ratio (i.e., when the air-fuel ratio is richer than the target air-fuel ratio), the air-fuel ratio is controlled so as to become larger toward the target air-fuel ratio. As a method for increasing the air-fuel ratio toward the target air-fuel ratio, a method that involves decreasing the fuel supply amount, or a method that involves increasing the air supply amount, or both of these methods, may be employed for example. Also, as a method for decreasing the air-fuel ratio toward the target air-fuel ratio, a method that involves increasing the fuel supply amount, or a method that involves decreasing the air supply amount, or both of these methods, may be employed for example.

Also, in this example embodiment, when there is an air-fuel ratio imbalance, and as a result, the exhaust emission characteristic is reduced, the target air-fuel ratio is corrected so that the exhaust emission characteristic comes to match a desired characteristic. Here, the correction amount for the target air-fuel ratio (hereinafter, this correction amount will be referred to as the “imbalance air-fuel ratio correction amount”) is set according to whether engine operation control according to the CD mode (i.e., control of the internal combustion engine that is selected when the CD mode is selected) is being executed, or whether engine operation control according to the CS mode (i.e., control of the internal combustion engine that is selected when the CS mode is selected) is being executed. In other words, while engine operation control according to the CD mode is being executed, the imbalance air-fuel ratio correction amount is set according to a rule that is different from a rule used for setting the imbalance air-fuel ratio correction amount while the engine operation control according to the CS mode is being executed. On the other hand, while the engine operation control according to the CS mode is being executed, the imbalance air-fuel ratio correction amount is set according to a rule that is different from a rule used for setting the imbalance air-fuel ratio correction amount while the engine operation control according to the CD mode is being executed.

According to this example embodiment, the effects described below are able to be obtained. That is, with the engine operation control according to the CD mode, the ratio of the engine operating period is relatively small, and with the engine operation control according to the CS mode, the ratio of the engine operating period is relatively large. Therefore, when there is an air-fuel ratio imbalance, the imbalance air-fuel ratio correction amount for maintaining the exhaust emission characteristic at the desired characteristic is naturally different when the engine operation control according to the CD mode is being executed, than it is when the engine operation control according to the CS mode is being executed, even if the air-fuel ratio imbalance is the same. Therefore, if the imbalance air-fuel ratio correction amount when the engine operation control according to the CD mode is being executed and the imbalance air-fuel ratio correction amount when the engine operation control according to the CS mode is being executed are set based on the same approach, the exhaust emission characteristic may not come to match the desired characteristic. That is, in order to reliably keep the exhaust emission characteristic at the desired characteristic, when the engine operation control according to the CD mode is being executed, the imbalance air-fuel ratio correction amount should be set to an imbalance air-fuel ratio correction amount suitable for this case. Also, when the engine operation control according to the CS mode is being executed, the imbalance air-fuel ratio correction amount should be set to an imbalance air-fuel ratio correction amount suitable for this case. Here, in this example embodiment, the imbalance air-fuel ratio correction amount is set according to whether the engine operation control according to the CD mode is being executed or whether the engine operation control according to the CS mode is being executed. Therefore, according to this example embodiment, when the engine operation control according to the CD mode is being executed, the imbalance air-fuel ratio correction amount is able to be set to an imbalance air-fuel ratio correction amount that is suitable for this case, and when the engine operation control according to the CS mode is being executed, the imbalance air-fuel ratio correction amount is able to be set to an imbalance air-fuel ratio correction amount that is suitable for this case. Therefore, according to this example embodiment, the exhaust emission characteristic is able to be kept at the desired characteristic, regardless of the control mode, and as a result, a good exhaust emission characteristic is able to be maintained.

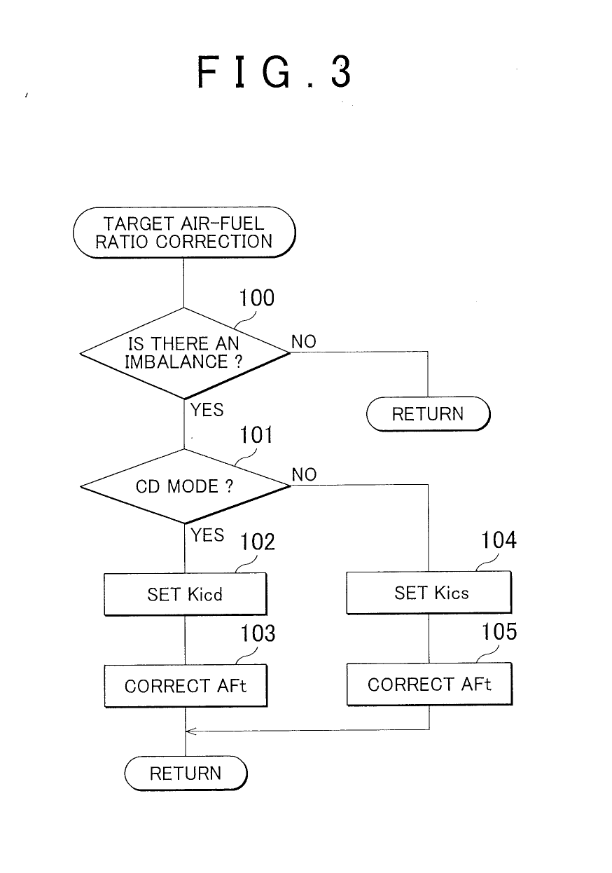

Next, an example of a routine for executing the target air-fuel ratio correction of this example embodiment will be described. FIG. 3 shows one example of this routine. This routine is a routine that starts in regular predetermined cycles.

When the routine shown in FIG. 3 starts, first in step S100, it is determined whether there is an air-fuel ratio imbalance. If it is determined that there is an air-fuel ratio imbalance, the routine proceeds on to step S101. On the other hand, if it is determined that there is not an air-fuel ratio imbalance, the routine ends. In this case, the target air-fuel ratio is not corrected.

In step S101, it is determined whether the current control mode is the CD mode. If it is determined that the current control mode is the CD mode, the routine proceeds on to step S102. On the other hand, if it is determined that the current control mode is not the CD mode (i.e., if it is determined that the current control mode is the CS mode), the routine proceeds on to step S104.

In step S102, an imbalance air-fuel ratio correction amount Kicd suitable for when the control mode is the CD mode is set. Then in step S103, a target air-fuel ratio AFt is corrected based on the imbalance air-fuel ratio correction amount Kicd set in step S102, and then the routine ends.

In step S104, an imbalance air-fuel ratio correction amount Kics suitable for when the control mode is the CS mode is set. Then in step S105, the target air-fuel ratio AFt is corrected based on the imbalance air-fuel ratio correction amount Kics set in step S104, and then the routine ends.

In this example embodiment, provided the condition relating to an engine operating state (i.e., the operating state of the engine) is the same, the imbalance air-fuel ratio correction amount set when the CD mode is selected (hereinafter, this imbalance air-fuel ratio correction amount may also be referred to as the “CD mode imbalance air-fuel ratio correction amount”) is preferably smaller than the imbalance air-fuel ratio correction amount set when the CS mode is selected (hereinafter, this imbalance air-fuel ratio correction amount may also be referred to as the “CS mode imbalance air-fuel ratio correction amount”).

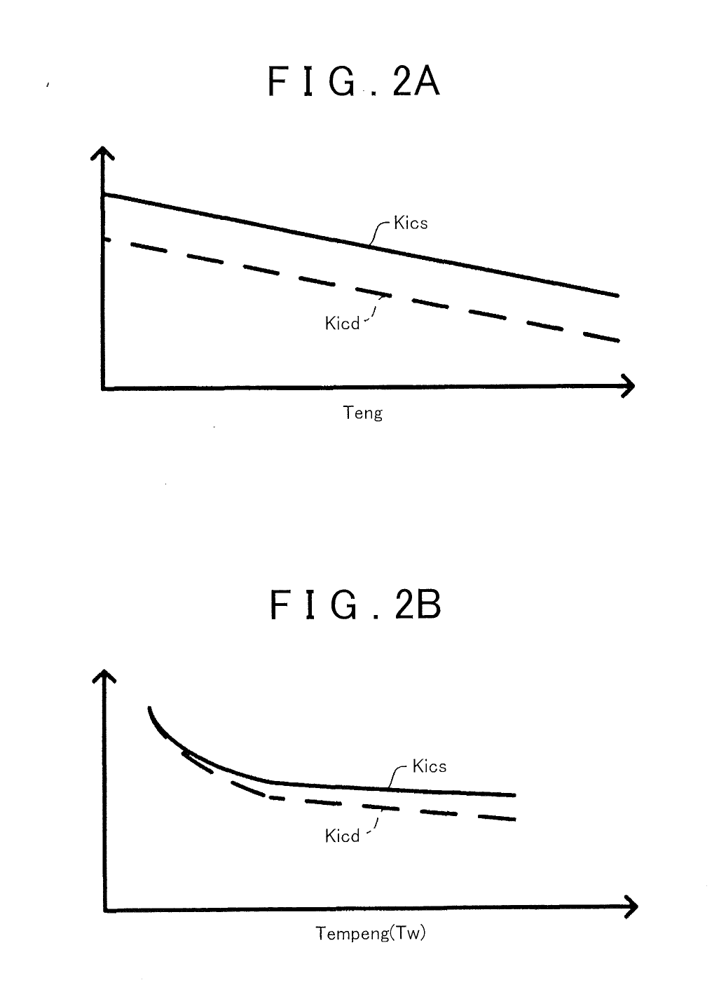

Also in this example embodiment, for example, as shown in FIG. 2A, the CD mode imbalance air-fuel ratio correction amount Kicd may be set to a smaller value as the time Teng elapsed after engine operation starts becomes longer. Also, the CS mode imbalance air-fuel ratio correction amount Kics may be set to a smaller value as the time Teng elapsed after engine operation starts becomes longer.

Also, in this example embodiment, for example, as shown in FIG. 2B, the CD mode imbalance air-fuel ratio correction amount Kicd may be set to a smaller value the higher the temperature Tempeng of the internal combustion engine (or the temperature Tw of coolant that cools the internal combustion engine) is. The CS mode imbalance air-fuel ratio correction amount Kics may be set to a smaller value the higher the temperature Tempeng of the internal combustion engine (or the temperature Tw of coolant that cools the internal combustion engine) is.

Also, in this example embodiment, the imbalance air-fuel ratio correction amount may be any correction amount as long as it is a correction amount that makes the exhaust emission characteristic match the desired characteristic. For example, when there is an air-fuel ratio imbalance in which the air-fuel ratio of a specific combustion chamber is richer than the air-fuel ratios of the remaining combustion chambers, an imbalance air-fuel ratio correction amount that increases the target air-fuel ratio (i.e., an imbalance air-fuel ratio correction amount that changes the target air-fuel ratio to the lean side) may be set, and when there is an air-fuel ratio imbalance in which the air-fuel ratio of a specific combustion chamber is leaner than the air-fuel ratios of the remaining combustion chambers, an imbalance air-fuel ratio correction amount that decreases the target air-fuel ratio (i.e., an imbalance air-fuel ratio correction amount that changes the target air-fuel ratio to the rich side) may be set.

Also, in this example embodiment, the selection of the control mode for either selecting the CD mode or selecting the CS mode may be performed suitably according to various demands on the hybrid power unit.

As a method for selecting the control mode, for example, a selection method may be employed that involves selecting the CD mode when it is desirable to consume battery power (i.e., electric power stored in the battery) until the amount of battery power (i.e., the amount of electric power stored in the battery) becomes extremely low, and selecting the CS mode when it is desirable to retain a comparatively large amount of battery power. In other words, as a method for selecting the control mode, a selection method may be employed that involves selecting the CD mode when there is a request to give priority to consuming battery power over ensuring that there be at least a predetermined amount of electric power in the battery, and selecting the CS mode when there is a request to give priority to ensuring that there be at least a predetermined amount of electric power in the battery over consuming battery power.

When this selection method is employed, operation of the internal combustion engine and driving of the second motor-generator are controlled as described below, for example. That is, in this case, the minimum amount of battery power that should be ensured when the CD is selected is set as a CD mode lower limit value, and the minimum amount of battery power that should be ensured when the CS is selected is set as a CS mode lower limit value. Here, the CD mode lower limit value is set to a value that is smaller than the CS mode lower limit value.

Also, when the CD mode is selected, while the amount of battery power is equal to or greater than the CD mode lower limit value, operation of the internal combustion engine is stopped, and the second motor-generator is driven by battery power, and the power output from the second motor-generator is output from the hybrid power unit. On the other hand, when the CD mode is selected and the amount of battery power becomes smaller than the CD mode lower limit value, the internal combustion engine is operated and the power output from the internal combustion engine is input to the first motor-generator, at least until the amount of battery power becomes equal to or greater than the CD mode lower limit value. As a result, electric power is generated by the first motor-generator, and this generated electric power is stored in the battery.

On the other hand, when the CS mode is selected, while the amount of battery power is equal to or greater than the CS mode lower limit value, operation of the internal combustion engine is stopped and the second motor-generator is driven by battery power, and the power output from the second motor-generator is output from the hybrid power unit. On the other hand, when the CS mode is selected and the amount of battery power becomes smaller than the CS mode lower limit value, the internal combustion engine is operated and the power output from the internal combustion engine is input to the first motor-generator, at least until the amount of battery power becomes equal to or greater than the CS mode lower limit value. As a result, electric power is generated by the first motor-generator, and this generated electric power is stored in the battery.

Even if the amount of battery power is equal to or greater than the CD mode lower limit value or equal to or greater than the CS mode lower limit value, the internal combustion engine may be operated and the power output from the internal combustion engine may be added to the power output from the second motor-generator, and this combined power may be output from the hybrid power unit, only when the power required as the power output from the hybrid power unit (hereinafter, this power will be referred to as the “required power”) is unable to be output from only the second motor-generator. Also, when the amount of battery power is smaller than the CD mode lower limit value or the CS mode lower limit value, the power output from the internal combustion engine may be added to the power output from the second motor-generator, and this combined power may be output from the hybrid power unit, only when the required power is unable to be output from only the second motor-generator. Also, when the amount of battery power is smaller than the CD mode lower limit value or the CS mode lower limit value, the internal combustion engine may be operated only when the fuel efficiency of the internal combustion engine when the internal combustion engine is operated is higher than a predetermined fuel efficiency.

A so-called plug-in hybrid vehicle is known in which not only is the battery able to be charged with electric power generated by the first motor-generator using the power of the internal combustion engine, but the battery is also able, to be charged with external power such as household power or the like. When the invention is applied to this vehicle and a large amount of external power is stored in the battery, the CD mode is selected.

Also, one possible method for selecting the control mode, for example, involves selecting the CD mode when the amount of battery power is equal to or greater than an allowable lower limit value (i.e., a predetermined amount of battery power; the minimal amount of battery power that should be ensured as the amount of battery power), and selecting the CS mode when the amount of battery power is smaller than this allowable lower limit value.

When this selection method is employed, operation of the internal combustion engine and driving of the second motor-generator are controlled as described below, for example. That is, when the CD mode is selected, basically, operation of the internal combustion engine is stopped and the second motor-generator is driven by battery power, and the power output from the second motor-generator is output from the hybrid power unit. Also, only when the required power is unable to be output from only the second motor-generator, the internal combustion engine is operated and the power output from the internal combustion engine is added to the power output from the second motor-generator, and the combined power is output from the hybrid power unit.

On the other hand, when the CS mode is selected, the internal combustion engine is operated and the second motor-generator is driven by battery power. Here, the power output from the internal combustion engine is input to the first motor-generator, and as a result, electric power is generated by the first motor-generator, and this generated electric power is stored in the battery.

Regardless of whether the CD mode is selected or the CS mode is selected, the internal combustion engine may be operated only when the fuel efficiency of the internal combustion engine when the internal combustion engine is operated is higher than a predetermined fuel efficiency. In particular, when the CS mode is selected, operation of the internal combustion engine may be stopped when the vehicle provided with the hybrid power unit described above is stopped.

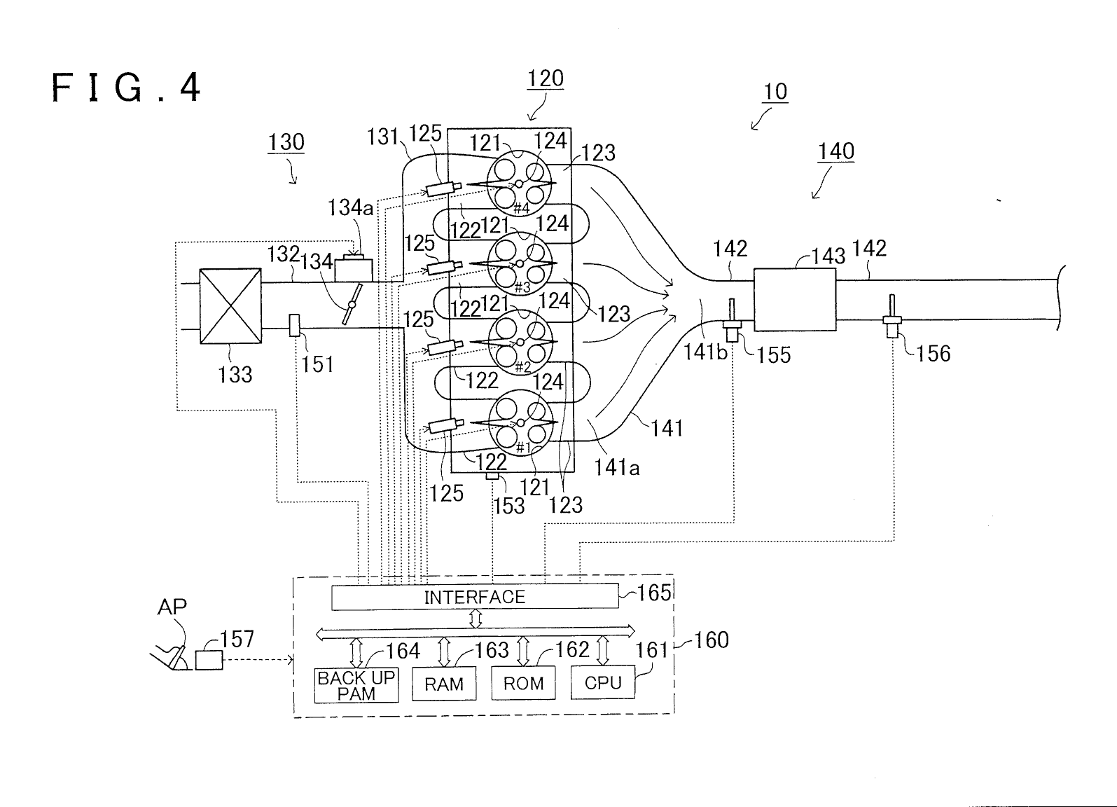

Next, a more specific example of the air-fuel ratio control of this example embodiment will be described. Here, the air-fuel ratio control of the internal combustion engine shown in FIG. 4 will be described. The internal combustion engine 10 shown in FIG. 4 is a spark-ignition internal combustion engine, just like the internal combustion engine 10 shown in FIG. 1. This internal combustion engine 10 is a so-called four-cycle internal combustion engine in which four strokes, i.e., an intake stroke, a compression stroke, an expansion stroke, and an exhaust stroke, are repeatedly performed in order. The internal combustion engine 10 shown in FIG. 4 has a main body (hereinafter, this main body will be referred to as an “engine body”) 120. The engine body 120 has a cylinder block and a cylinder head. The engine body 120 also has four combustion chambers 121, each of which is formed by an inner wall surface of a cylinder bore formed inside the cylinder block, a top surface of a piston arranged in the cylinder bore, and a lower wall surface of the cylinder head.

In FIG. 4, #1 denotes a first cylinder (i.e., the combustion chamber shown farthest down in the drawing), #2 denotes a second cylinder (i.e., the combustion chamber that is immediately above the first cylinder #1 in the drawing), #3 denotes a third cylinder (i.e., the, combustion chamber that is immediately above the second cylinder #2 in the drawing), and #4 denotes a fourth cylinder (i.e., the combustion chamber that is immediately above the third cylinder #3 in the drawing).

Also, intake ports 122 that are communicated with the combustion chambers 121 are formed in the cylinder head. Air is drawn into the combustion chambers 121 via these intake ports 122. Each of the intake ports 122 is opened and closed by an intake valve, not shown. Furthermore, exhaust ports 123 that are communicated with the combustion chambers 121 are also formed in the cylinder head. Exhaust gas is discharged from the combustion chambers 121 into these exhaust ports 123. Each of the exhaust ports 123 is opened and closed by an exhaust valve, not shown.

Also, a spark plug 124 is arranged corresponding to each of the combustion chambers 121, in the cylinder head. Each of the spark plugs 124 is arranged in the cylinder head so as to be exposed inside the combustion chambers 121 so as to be able to ignite an air-fuel mixture of fuel and air that forms in the combustion chambers 121. Moreover, a fuel injection valve 125 is arranged corresponding to each intake port 122, in the cylinder head. The fuel injection valves 125 are arranged in the cylinder head so as to be exposed inside the intake ports 122 to enable fuel to be injected into the intake ports 122.

An intake manifold 131 is connected to the intake ports 122. This intake manifold 131 has branch portions that are connected to each of the intake ports 122, and a surge tank portion where these branch portions converge. Also, an intake pipe 132 is connected to the surge tank portion of the intake manifold 131. In this specific example, the intake ports 122, the intake manifold 131, and the intake pipe 132 together form an intake passage 130. Also, an air filter 133 is arranged in the intake pipe 132. Moreover, a throttle valve 134 is pivotally arranged in the intake pipe 132 between the air filter 133 and the intake manifold 131. An actuator 134a that drives this throttle valve 134 is connected to the throttle valve 134. The flow path area inside the intake pipe 132 is able to be changed, and thus the amount of air drawn into the combustion chambers 121 is able to be controlled, by pivoting the throttle valve 134 using the actuator 134a.

An exhaust manifold 141 is connected to the exhaust ports 123. This exhaust manifold 141 has branch portions 141a that are connected to each of the exhaust ports 123, and an exhaust converging portion 141b where these these branch portions converge. Also, an exhaust pipe 142 is connected to the exhaust converging portion 141b. In this specific example, the exhaust ports 123, the exhaust manifold 141, and the exhaust pipe 142 together form an exhaust passage 140. Also, a catalyst 143 that purifies specific components in the exhaust gas is arranged in the exhaust pipe 142.

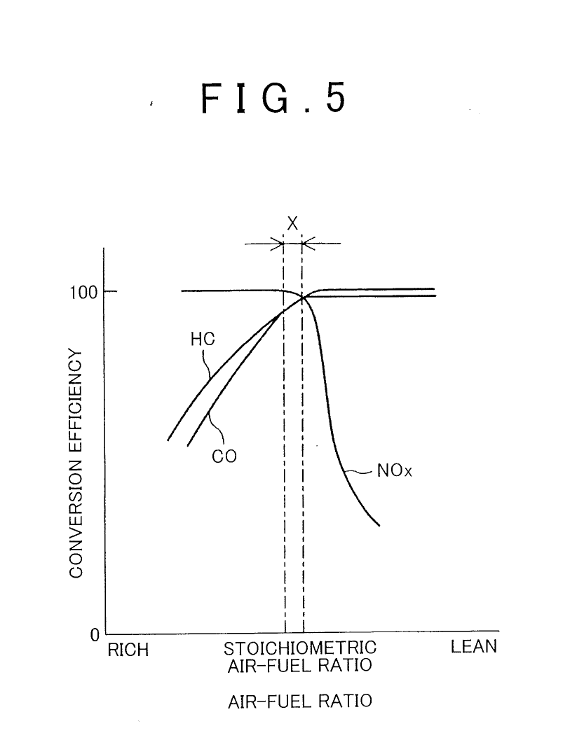

This catalyst 143 is a so-called three-way catalyst that is able to simultaneously purify oxides of nitrogen (hereinafter, this will be written as “NOx”), carbon monoxide (hereinafter, this will be written as “CO”), and hydrocarbons (hereinafter, these will be written as “HC”) in the exhaust gas with high conversion efficiency (i.e., at a high purification rate) when the temperature of the catalyst 143 is higher than a certain temperature (i.e., a so-called activation temperature) and the air-fuel ratio of exhaust gas flowing into the catalyst 143 (hereinafter, this air-fuel ratio of the exhaust gas may also be referred to as the “exhaust air-fuel ratio”) is within a range X in the vicinity of a stoichiometric air-fuel ratio, as shown in FIG. 5. Meanwhile, the catalyst 143 has the ability to store oxygen in the exhaust gas when the air-fuel ratio of the exhaust gas flowing into the catalyst 143 is leaner than the stoichiometric air-fuel ratio, and release the oxygen stored therein when the air-fuel ratio of the exhaust gas that flows into the catalyst 143 is richer than the stoichiometric air-fuel ratio (hereinafter, this ability will be referred to as an “oxygen storing and releasing ability”). Therefore, as long as this oxygen storing and releasing ability is functioning properly, even if the air-fuel ratio of the exhaust gas that flows into the catalyst 143 is leaner or richer than the stoichiometric air-fuel ratio, the atmosphere inside the catalyst 143 is able to be maintained substantially near the stoichiometric air-fuel ratio, so NOx, CO, and HC in the exhaust gas are able to be simultaneously purified with high conversion efficiency in the catalyst 143.

An airflow meter 151 that detects the amount of air flowing through the intake pipe 132, i.e., the amount of air drawn into the combustion chambers 121 (hereinafter, this amount of air will be referred to as the “intake air amount”) is arranged in the intake pipe 132.

A crank position sensor 153 that detects a rotation phase of a crankshaft, not shown, is arranged on the engine body 120. This crank position sensor 153 outputs a narrow pulse every time the crankshaft rotates 10°, and outputs a wide pulse every time the crankshaft rotates 360°. The rotation speed of the crankshaft, i.e., the engine speed, is able to be calculated based on these pulses. Also, an accelerator operation amount sensor 157 detects a depression amount of an accelerator pedal AP.

An air-fuel ratio sensor (hereinafter, this air-fuel ratio will be referred to as the “upstream air-fuel ratio sensor”) 155 that detects the exhaust air-fuel ratio is arranged in the exhaust pipe 142 upstream of the catalyst 143. Moreover, an air-fuel ratio sensor (hereinafter, this air-fuel ratio will be referred to as the “downstream air-fuel ratio sensor”) 156 that similarly detects the exhaust air-fuel ratio is arranged in the exhaust pipe 142 downstream of the catalyst 143.

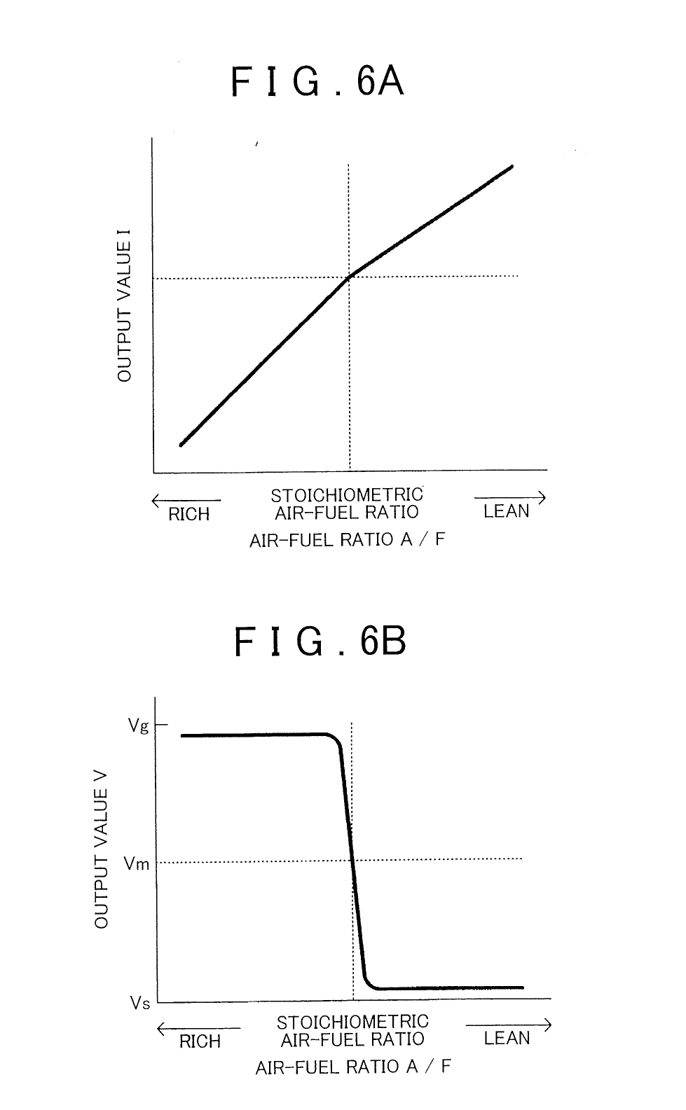

The upstream air-fuel ratio sensor 155 is a so-called limiting current-type oxygen concentration sensor that outputs a smaller output value I the richer the detected exhaust air-fuel ratio is, and outputs a larger output value I the leaner the detected exhaust air-fuel ratio is, as shown in FIG. 6A.

The downstream air-fuel ratio sensor 156 is a so-called electromotive force-type oxygen concentration sensor that outputs a relatively large constant output value Vg when the detected exhaust air-fuel ratio is richer than the stoichiometric air-fuel ratio, outputs a relatively small constant output value Vs when the detected exhaust air-fuel ratio is leaner than the stoichiometric air-fuel ratio, and outputs an output value Vm that is in the middle between the relatively large constant output value Vg and the relatively small constant output value Vs when the detected exhaust air-fuel ratio is at the stoichiometric air-fuel ratio.

A controller (ECU) 160 shown in FIG. 4 is formed by a microcomputer and includes a CPU (a microprocessor) 161, ROM (Read-Only Memory) 162, RAM (Random Access Memory) 163, backup RAM 164, and an interface 165 that includes an AD converter, all of which are connected together via a bidirectional bus. The interface 165 is connected to the spark plugs 124, the fuel injection valves 125, and the actuator 134a for the throttle valve 134. Also, the airflow meter 151, the crank position sensor 153, the upstream air-fuel ratio sensor 155, the downstream air-fuel ratio sensor 156, and the accelerator operation amount sensor 157 are also connected to the interface 165.

Here, with the air-fuel ratio control of this specific example, when it is detected that the exhaust air-fuel ratio is leaner than the target air-fuel ratio at the upstream air-fuel ratio sensor, the air-fuel ratio is leaner than the target air-fuel ratio. Therefore at this time, in this specific example, the air-fuel ratio is corrected so that it approaches the target air-fuel ratio, based on the exhaust air-fuel ratio detected by the upstream air-fuel ratio sensor. More specifically, the fuel injection quantity is increased. On the other hand, when it is detected that the exhaust air-fuel ratio is richer than the target air-fuel ratio at the upstream air-fuel ratio sensor, the air-fuel ratio is richer than the target air-fuel ratio. Therefore at this time, in this specific example, the air-fuel ratio is corrected so that it approaches the target air-fuel ratio, based on the exhaust air-fuel ratio detected by the upstream air-fuel ratio sensor. More specifically, the fuel injection quantity is decreased. Controlling the air-fuel ratio in this way enables the air-fuel ratio as a whole to be controlled to the target air-fuel ratio.

Also, with the air-fuel ratio control in this specific example, the target air-fuel ratio AFt is calculated by correcting an initial target air-fuel ratio (i.e., stoichiometric air-fuel ratio) AFst according to Expression 1 below, and this calculated target air-fuel ratio AFt is set as the target air-fuel ratio used in the air-fuel ratio control described above. In Expression 1 below, the term “Kb” represents a basic air-fuel ratio correction amount, and the term “Ki” represents an imbalance air-fuel ratio correction amount. These air-fuel ratio correction amounts will be described in order next.

AFt=AFst×Kb×Ki (1)

First, the basic air-fuel ratio correction amount Kb in Expression 1 above will be described. This basic air-fuel ratio correction amount is an air-fuel ratio correction amount that is set based on the exhaust air-fuel ratio detected by the downstream air-fuel ratio sensor. That is, in this specific example, when the exhaust air-fuel ratio detected by the downstream air-fuel ratio sensor is leaner than the target air-fuel ratio at that time, the basic air-fuel ratio correction amount at that time is reduced in order to change the target air-fuel ratio to the rich side. Then the target air-fuel ratio AFt is calculated according to Expression 1 above using this reduced basic air-fuel ratio correction amount. On the other hand, when the exhaust air-fuel ratio detected by the downstream air-fuel ratio sensor is richer than the target air-fuel ratio at that time, the basic air-fuel ratio correction amount at that time is increased in order to change the target air-fuel ratio to the lean side. Then the target air-fuel ratio AFt is calculated according to Expression 1 above using this increased basic air-fuel ratio correction amount.

Next, the imbalance air-fuel ratio correction amount Ki in Expression 1 above will be described. This imbalance air-fuel ratio correction amount Ki is an air-fuel ratio correction amount that is set based on an air-fuel ratio imbalance ratio (i.e., the amount of difference among air-fuel ratios in the combustion chambers).

That is, the internal combustion engine shown in FIG. 4 has four fuel injection valves. A phenomenon such as that described below occurs when there is a problem with one of these four fuel injection valves. That is, in this specific example, as described above, the quantity of fuel to be injected from each of the fuel injection valves is controlled such that the air-fuel ratio comes to match the target air-fuel ratio, based on the exhaust air-fuel ratio detected by the upstream air-fuel ratio sensor. That is, when it is determined that the air-fuel ratio is leaner than the target air-fuel ratio based on the exhaust air-fuel ratio detected by the upstream air-fuel ratio sensor, the fuel injection quantity is increased at each fuel injection valve. Also, when it is determined that the air-fuel ratio is richer than the target air-fuel ratio based on the exhaust air-fuel ratio detected by the upstream air-fuel ratio sensor, the fuel injection quantity is decreased at each fuel injection valve. In other words, in this specific example, the upstream air-fuel ratio sensor is not arranged for each combustion chamber, but rather is arranged so as to be shared among the combustion chambers. Therefore, when it is determined that the air-fuel ratio is leaner than the target air-fuel ratio, it will be determined that the air-fuel ratio is leaner than the target air-fuel ratio in all of the combustion chambers. Also, when it is determined that the air-fuel ratio is richer than the target air-fuel ratio, it will be determined that the air-fuel ratio is richer than the target air-fuel ratio in all of the combustion chambers. Therefore, when it is determined that the air-fuel ratio is leaner than the target air-fuel ratio, the fuel injection quantity is increased at all of the fuel injection valves, and when the it is determined that the air-fuel ratio is richer than the target air-fuel ratio, the fuel injection quantity is decreased at all of the fuel injection valves.

Here, for example, when a command is issued to the fuel injection valves from the controller so that the same quantity of fuel will be injected at all of the fuel injection valves, if there is a problem in which a larger quantity of fuel than the quantity of fuel called for by the controller (hereinafter, this quantity will be referred to as the “command fuel injection quantity”) ends up being injected, in one of the fuel injection valves (hereinafter, a fuel injection valve with this problem will be referred to as an “abnormal fuel injection valve”), even if fuel of the command fuel injection quantity is injected at the remaining fuel injection valves (hereinafter, these fuel injection valves will be referred to as “normal fuel injection valves”) such that the air-fuel ratios in the corresponding combustion chambers match the target air-fuel ratio, the air-fuel ratio in the combustion chamber corresponding to the abnormal fuel injection valve will end up being richer than the target air-fuel ratio. Accordingly, at this time, the emission characteristic of the exhaust gas discharged from the combustion chamber corresponding to the abnormal fuel injection valve will end up decreasing.

Also, when the exhaust gas discharged from the combustion chamber corresponding to the abnormal fuel injection valve reaches the upstream air-fuel ratio sensor, it will be determined that the air-fuel ratio is richer than the target air-fuel ratio, and the fuel injection quantity will be decreased at all of the fuel injection valves. As a result, the air-fuel ratios in the combustion chambers corresponding to the normal fuel injection valves will end up becoming leaner than the target air-fuel ratio. Accordingly, at this time, the emission characteristic of the exhaust gas discharged from the combustion chambers corresponding to the normal fuel injection valves will also end up decreasing.

Of course, even if the air-fuel ratio in the combustion chamber corresponding to the abnormal fuel injection valve becomes richer than the target air-fuel ratio, or even if the air-fuel ratios in the combustion chambers corresponding to the normal fuel injection valves become leaner than the target air-fuel ratio, according to the air-fuel ratio control of this specific example, the fuel injection quantity is controlled at each fuel injection valve so that the air-fuel ratio of each combustion chamber will come to match the target air-fuel ratio. Therefore, overall, the air-fuel ratio is controlled to the target air-fuel ratio. However, even if overall the air-fuel ratio is controlled to the target air-fuel ratio, when the air-fuel ratios in the combustion chambers are viewed separately, while the air-fuel ratio control of this specific example is being executed, the air-fuel ratio is significantly richer or significantly leaner than the target air-fuel ratio. Therefore, in either case, the emission characteristic of the exhaust gas discharged from the combustion chamber will decrease.

On the other hand, when a command is issued to the fuel injection valves from the controller so that the same quantity of fuel will be injected at all of the fuel injection valves, if there is a problem in which a only a smaller quantity of fuel than the quantity of fuel of the command fuel injection quantity called for by the controller ends up being injected, in one of the fuel injection valves (hereinafter, a fuel injection valve with this problem will be referred to as an “abnormal fuel injection valve”), even if fuel of the command fuel injection quantity is injected at the remaining normal fuel injection valves such that the air-fuel ratios in the corresponding combustion chambers match the target air-fuel ratio, the air-fuel ratio in the combustion chamber corresponding to the abnormal fuel injection valve will end up being leaner than the target air-fuel ratio. Accordingly, at this time, the emission characteristic of the exhaust gas discharged from the combustion chamber corresponding to the abnormal fuel injection valve will end up decreasing.

Also, when the exhaust gas discharged from the combustion chamber corresponding to the abnormal fuel injection valve reaches the upstream air-fuel ratio sensor, it will be determined that the air-fuel ratio is leaner than the target air-fuel ratio, and the fuel injection quantity will be increased at all of the fuel injection valves. As a result, the air-fuel ratios in the combustion chambers corresponding to the normal fuel injection valves will end up becoming richer than the target air-fuel ratio. Accordingly, at this time, the emission characteristic of the exhaust gas discharged from the combustion chamber corresponding to the normal fuel injection valves will also end up decreasing.

Of course, even if the air-fuel ratio in the combustion chamber corresponding to the abnormal fuel injection valve becomes leaner than the target air-fuel ratio, or even if the air-fuel ratios in the combustion chambers corresponding to the normal fuel injection valves become richer than the target air-fuel ratio, according to the air-fuel ratio control of this specific example, the fuel injection quantity is controlled at each fuel injection valve so that the air-fuel ratio of each combustion chamber will come to match the target air-fuel ratio. Therefore, overall, the air-fuel ratio is controlled to the target air-fuel ratio. However, even if overall the air-fuel ratio is controlled to the target air-fuel ratio, when the air-fuel ratios in the combustion chambers are viewed separately, while the air-fuel ratio control of this specific example is being executed, the air-fuel ratio is significantly leaner or significantly richer than the target air-fuel ratio. Therefore, in either case, the emission characteristic of the exhaust gas discharged from the combustion chamber will decrease.

In this way, if there a problem in which a larger quantity of fuel than the command fuel injection quantity ends up being injected in a specific fuel injection valve, or if there a problem in which only a smaller quantity of fuel than the command fuel injection quantity ends up being injected in a specific fuel injection valve, the emission characteristic of the exhaust gas discharged from the combustion chamber will decrease.

In view of this situation, if there is a problem with a specific fuel injection valve, and it is known that a state exists in which a larger quantity of fuel than the command fuel injection quantity is injected at the fuel injection valve, or a state exists in which only a smaller quantity of fuel than the command fuel injection quantity is injected at the fuel injection valve, in other words, that there is an air-fuel ratio imbalance, it is extremely important that this air-fuel ratio imbalance be eliminated (i.e., corrected) in order to improve the emission characteristic of the exhaust gas.

Therefore, in this specific example, when a determination as to whether there is an air-fuel ratio imbalance is made based on the knowledge described below and there is an air-fuel ratio imbalance, the imbalance air-fuel ratio correction amount that corrects the target air-fuel ratio to eliminate (i.e., correct) this air-fuel ratio imbalance is set.

That is, when the rotation angle of the crankshaft is referred to as the crank angle, in an internal combustion engine, the exhaust stroke is sequentially performed in the first cylinder, the fourth cylinder, the third cylinder, and the second cylinder, in this order, at timings offset by 180° of crank angle in the combustion chambers. Therefore, exhaust gas is sequentially discharged from the combustion chambers every 180° of crank angle, so these exhaust gases will reach the upstream air-fuel ratio sensor sequentially. Thus, the upstream air-fuel ratio sensor generally sequentially detects the air-fuel ratio of the exhaust gas discharged from the first cylinder, the air-fuel ratio of the exhaust gas discharged from the fourth cylinder, the air-fuel ratio of the exhaust gas discharged from the third cylinder, and the air-fuel ratio of the exhaust gas discharged from the second cylinder.

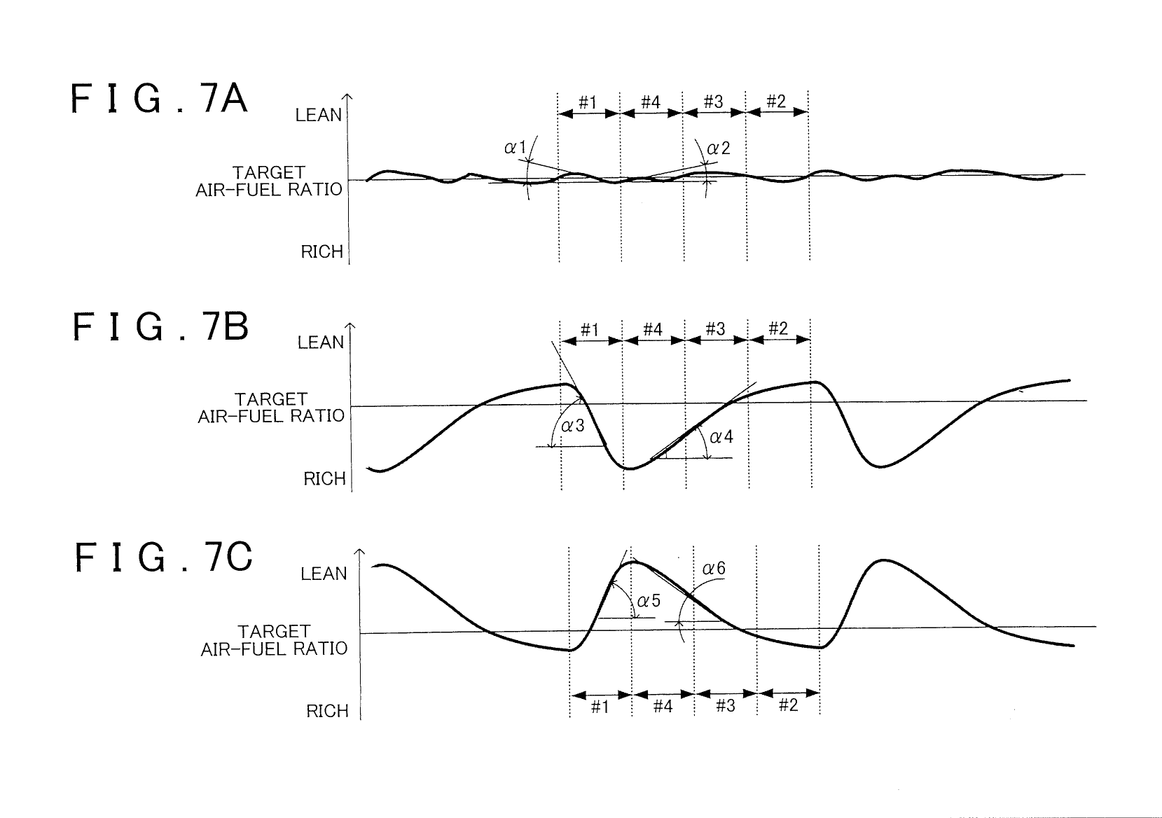

Here, if all of the fuel injection valves are normal, the output value output from the upstream air-fuel ratio sensor that corresponds to the air-fuel ratio of the exhaust gas that has reached the upstream air-fuel ratio sensor (hereinafter, this output value will be referred to as the “upstream air-fuel ratio sensor output value”) will change in the manner shown in FIG. 7A. That is, as described above, according to the air-fuel ratio control of this specific example, when an attempt is made to control the air-fuel ratios in the combustion chambers to the target air-fuel ratio, the air-fuel ratios in the combustion chambers are controlled on the whole to the target air-fuel ratio by being made richer or leaner than the target air-fuel ratio. When the upstream air-fuel ratio sensor detects that the air-fuel ratio is leaner than the target air-fuel ratio, an increase value for the fuel injection quantity of each of the fuel injection valves is set such that the air-fuel ratio will reach the stoichiometric air-fuel ratio as quickly as possible. Also, when the upstream air-fuel ratio sensor detects that the air-fuel ratio is richer than the target air-fuel ratio, a decrease value for the fuel injection quantity of each of the fuel injection valves is set such that the air-fuel ratio will reach the stoichiometric air-fuel ratio as quickly as possible. Therefore, if all of the fuel injection valves are normal, the upstream air-fuel ratio sensor output value will repeatedly move up and down within a relatively narrow range, crossing back and forth over the upstream air-fuel ratio sensor output value corresponding to the target air-fuel ratio, as shown in FIG. 7A.

On the other hand, if there is a problem in which a larger quantity of fuel than the command fuel injection quantity ends up being injected in the fuel injection valve corresponding to the first cylinder, and the fuel injection valves corresponding to the remaining cylinders are normal, the upstream air-fuel ratio sensor output value will change in the manner shown in FIG. 7B. That is, the air-fuel ratio of the first cylinder corresponding to the abnormal fuel injection valve is significantly richer than the target air-fuel ratio, so the air-fuel ratio of the exhaust gas discharged from the first cylinder is also significantly richer than the target air-fuel ratio. Therefore, when the exhaust gas discharged from the first cylinder reaches the upstream air-fuel ratio sensor, the upstream air-fuel ratio sensor output value will all at once become smaller toward an output value corresponding to the air-fuel ratio of the exhaust gas discharged from the first cylinder, i.e., a significantly richer air-fuel ratio than the target air-fuel ratio. Also, according to the air-fuel ratio control of this specific example, when the upstream air-fuel ratio sensor output value is an output value corresponding to a significantly richer air-fuel ratio than the target air-fuel ratio, i.e., when the upstream air-fuel ratio sensor detects a significantly richer air-fuel ratio than the target air-fuel ratio, the fuel injection quantities of all of the fuel injection valves are significantly reduced, such that the air-fuel ratios of the fourth cylinder, the third cylinder, and the second cylinder become significantly leaner than the target air-fuel ratio. Therefore, when the exhaust gases discharged from the fourth cylinder to the second cylinder reach the upstream air-fuel ratio sensor, the upstream air-fuel ratio sensor output value will all at once become larger toward an output value corresponding to the air-fuel ratios of the exhaust gases discharged from these cylinders, i.e., significantly leaner air-fuel ratios than the target air-fuel ratio. Also, according to the air-fuel ratio control of this specific example, when the upstream air-fuel ratio sensor output value is an output value corresponding to a leaner air-fuel ratio than the target air-fuel ratio, i.e., when the upstream air-fuel ratio sensor detects a leaner air-fuel ratio than the target air-fuel ratio, the fuel injection quantities of all of the fuel injection valves are increased, such that the air-fuel ratio of the first cylinder becomes significantly richer than the target air-fuel ratio again. Therefore, when there is a problem in which a larger quantity of fuel than the command fuel injection quantity ends up being injected in a specific fuel injection valve, the upstream air-fuel ratio sensor output value will repeatedly move up and down within a relatively large range, crossing back and forth over the upstream air-fuel ratio sensor output value corresponding to the target air-fuel ratio, as shown in FIG. 7B.

On the other hand, if there is a problem in which a only a smaller quantity of fuel than the command fuel injection quantity ends up being injected in the fuel injection valve corresponding to the first cylinder, and the fuel injection valves corresponding to the remaining cylinders are normal, the upstream air-fuel ratio sensor output value, will change in the manner shown in FIG. 7C. That is, the air-fuel ratio of the first cylinder corresponding to the abnormal fuel injection valve is significantly leaner than the target air-fuel ratio, so the air-fuel ratio of the exhaust gas discharged from the first cylinder is also significantly leaner than the target air-fuel ratio. Therefore, when the exhaust gas discharged from the first cylinder reaches the upstream air-fuel ratio sensor, the upstream air-fuel ratio sensor output value will all at once become larger toward an output value corresponding to the air-fuel ratio of the exhaust gas discharged from the first cylinder, i.e., a significantly leaner air-fuel ratio than the target air-fuel ratio. Also, according to the air-fuel ratio control of this specific example, when the upstream air-fuel ratio sensor output value is an output value corresponding to a significantly leaner air-fuel ratio than the target air-fuel ratio, i.e., when the upstream air-fuel ratio sensor detects a significantly leaner air-fuel ratio than the target air-fuel ratio, the fuel injection quantities of all of the fuel injection valves are significantly increased, such that the air-fuel ratios of the fourth cylinder, the third cylinder, and the second cylinder become significantly richer than the target air-fuel ratio. Therefore, when the exhaust gases discharged from the fourth cylinder to the second cylinder reach the upstream air-fuel ratio sensor, the upstream air-fuel ratio sensor output value will all at once become smaller toward an output value corresponding to the air-fuel ratios of the exhaust gases discharged from these cylinders, i.e., significantly richer air-fuel ratios than the target air-fuel ratio. Also, according to the air-fuel ratio control of this specific example, when the upstream air-fuel ratio sensor output value is an output value corresponding to a richer air-fuel ratio than the target air-fuel ratio, i.e., when the upstream air-fuel ratio sensor detects a significantly richer air-fuel ratio than the target air-fuel ratio, the fuel injection quantities of all of the fuel injection valves are reduced, such that the air-fuel ratio of the first cylinder becomes significantly leaner than the target air-fuel ratio again. Therefore, when there is a problem in which only a smaller quantity of fuel than the command fuel injection quantity ends up being injected in a specific fuel injection valve, the upstream air-fuel ratio sensor output value will repeatedly move up and down within a relatively large range, crossing back and forth over the upstream air-fuel ratio sensor output value corresponding to the target air-fuel ratio, as shown in FIG. 7C.

In this way, the change in the upstream air-fuel ratio sensor output value when there is an abnormality in a specific fuel injection valve is very different from a change in the upstream air-fuel ratio sensor output value when all of the fuel injection valves are normal.

In particular, when all of the fuel injection valves are normal and the upstream air-fuel ratio sensor output value becomes smaller following a change toward the rich side in the air-fuel ratio of the exhaust gas that reaches the upstream air-fuel ratio sensor, the average slope of a line following the upstream air-fuel ratio sensor output values (hereinafter, this average slope will simply be referred to as the “slope”) is a relatively small slope α1, as shown in FIG. 7A. On the other hand, when all of the fuel injection valves are normal and the upstream air-fuel ratio sensor output value becomes larger following a change toward the lean side in the air-fuel ratio of the exhaust gas that reaches the upstream air-fuel ratio sensor, the average slope of a line following the upstream air-fuel ratio sensor output values (hereinafter, this average slope will also simply be referred to as the “slope”) is a relatively small slope α2, also as shown in FIG. 7A. In this case, the absolute value of the slope α1 and the absolute value of the slope α2 are substantially equal.

Therefore, the absolute value of the slope α1 (or the absolute value of the slope α2) is set as a reference slope.

On the other hand, when there is an abnormality in a specific fuel injection valve, in which a larger quantity of fuel than the command fuel injection quantity ends up being injected, and the upstream air-fuel ratio sensor output value becomes smaller following a change toward the rich side in the air-fuel ratio of the exhaust gas that reaches the upstream air-fuel ratio sensor, the slope of a line following the upstream air-fuel ratio sensor output values is a relatively large slope α3, as shown in FIG. 7B. On the other hand, when there is an abnormality in a specific fuel injection valve, in which a larger quantity of fuel than the command fuel injection quantity ends up being injected, and the upstream air-fuel ratio sensor output value becomes larger following a change toward the lean side in the air-fuel ratio of the exhaust gas that reaches the upstream air-fuel ratio sensor, the slope of a line following the upstream air-fuel ratio sensor output values is a relatively large slope α4, also as shown in FIG. 7B. Also in this case, the absolute value of the slope α3 of the line following the upstream air-fuel ratio sensor output values when the upstream air-fuel ratio sensor output value becomes smaller is slightly larger than the absolute value of the slope α4 of the line following the upstream air-fuel ratio sensor output values when the upstream air-fuel ratio sensor output value becomes larger. Also, the absolute values of the slope α3 and the slope α4 become larger as the air-fuel ratio imbalance ratio increases.

Therefore, in this specific example, when the absolute value of the slope when the upstream air-fuel ratio sensor output value becomes smaller (this slope is the slope corresponding to the slope α3 in FIG. 7B), or the absolute value of the slope when the upstream air-fuel ratio sensor output value becomes larger (this slope is the slope corresponding to the slope α4 in FIG. 7B) is larger than the reference slope, and the absolute value of the slope when the upstream air-fuel ratio sensor output value becomes smaller is larger than the absolute value of the slope when the upstream air-fuel ratio sensor output value becomes larger, it is determined that there is an air-fuel ratio imbalance in which a larger quantity of fuel than the command fuel injection quantity ends up being injected in a specific fuel injection valve. Also, when it is determined that there is an air-fuel ratio imbalance in which a larger quantity of fuel than the command fuel injection quantity ends up being injected in a specific fuel injection valve, the imbalance air-fuel ratio correction amount at that time is increased in order to increase the target air-fuel ratio (i.e., in order to change the target air-fuel ratio to the lean side) so that the exhaust imbalance characteristic will come to match a desired characteristic. At this time, the imbalance air-fuel ratio correction amount is made larger according to the absolute value of the slope when the upstream air-fuel ratio sensor output value becomes smaller (or the absolute value of the slope when the upstream air-fuel ratio sensor output value becomes larger). More specifically, the imbalance air-fuel ratio correction amount is made larger the larger the absolute value of the slope at this time is. Also, this increased air-fuel ratio correction amount is corrected according to whether the CD mode is selected as the engine control mode or the CS mode is selected as the engine control mode. More specifically, this increased imbalance air-fuel ratio correction amount is corrected such that the post-correction imbalance air-fuel ratio correction amount when the CD mode is selected will be smaller than the post-correction imbalance air-fuel ratio correction amount when the CS mode is selected. Then the target air-fuel ratio AFt is calculated according to Expression 1 above using this corrected imbalance air-fuel ratio correction amount.

On the other hand, when there is an abnormality in which only a smaller quantity of fuel than the command fuel injection quantity ends up being injected in a specific fuel injection valve, and the upstream air-fuel ratio sensor output value becomes larger following a change toward the lean side in the air-fuel ratio of the exhaust gas that reaches the upstream air-fuel ratio sensor, the slope of a line following the upstream air-fuel ratio sensor output values is a relatively large slope α5, as shown in FIG. 7C. On the other hand, when there is an abnormality in which only a smaller quantity of fuel than the command fuel injection quantity ends up being injected in a specific fuel injection valve, and the upstream air-fuel ratio sensor output value becomes smaller following a change toward the rich side in the air-fuel ratio of the exhaust gas that reaches the upstream air-fuel ratio sensor, the slope of a line following the upstream air-fuel ratio sensor output values is a relatively large slope α6, also as shown in FIG. 7C. Also in this case, the absolute value of the slope α5 of the line following the upstream air-fuel ratio sensor output values when the upstream air-fuel ratio sensor output value becomes larger is slightly larger than the absolute value of the slope α6 of the line following the upstream air-fuel ratio sensor output values when the upstream air-fuel ratio sensor output value becomes smaller. Also, the absolute values of the slope α5 and the slope α6 become larger as the air-fuel ratio imbalance ratio increases.

Therefore, in this specific example, when the absolute value of the slope when the upstream air-fuel ratio sensor output value becomes larger (this slope is the slope corresponding to the slope α5 in FIG. 7C), or the absolute value of the slope when the upstream air-fuel ratio sensor output value becomes smaller (this slope is the slope corresponding to the slope α6 in FIG. 7C) is larger than the reference slope, and the absolute value of the slope when the upstream air-fuel ratio sensor output value becomes larger is larger than the absolute value of the slope when the upstream air-fuel ratio sensor output value becomes smaller, it is determined that there is an air-fuel ratio imbalance in which only a smaller quantity of fuel than the command fuel injection quantity will be injected in a specific fuel injection valve. Also, when it is determined that there is an air-fuel ratio imbalance in which only a smaller quantity of fuel than the command fuel injection quantity will be injected in a specific fuel injection valve, the imbalance air-fuel ratio correction amount at that time is decreased in order to decrease the target air-fuel ratio (i.e., in order to change the target air-fuel ratio to the rich side) so that the exhaust imbalance characteristic will come to match a desired characteristic. At this time, the imbalance air-fuel ratio correction amount is made smaller according to the absolute value of the slope when the upstream air-fuel ratio sensor output value becomes larger (or the absolute value of the slope when the upstream air-fuel ratio sensor output value becomes smaller). More specifically, the imbalance air-fuel ratio correction amount is made smaller the larger the absolute value of the slope at this time is. Also, this decreased air-fuel ratio correction amount is corrected according to whether the CD mode is selected as the engine control mode or the CS mode is selected as the engine control mode. More specifically, this decreased imbalance air-fuel ratio correction amount is corrected such that the post-correction imbalance air-fuel ratio correction amount when the CD mode is selected will be smaller than the post-correction imbalance air-fuel ratio correction amount when the CS mode is selected. Then the target air-fuel ratio AFt is calculated according to Expression 1 above using this corrected imbalance air-fuel ratio correction amount.

The internal combustion engine shown in FIG. 1 may be a spark-ignition internal combustion engine (a so-called gasoline engine), or a compression self-ignition internal combustion engine (a so-called diesel engine).

In the specific example, the difference among air-fuel ratios in the combustion chambers is detected using the slope of the upstream air-fuel ratio sensor output values, but another method may also be used as long as the existence of an air-fuel ratio imbalance, or the degree thereof, is able to be detected.

What is claimed is:

1. An air-fuel ratio control apparatus of a hybrid power unit provided with an electric motor and an internal combustion engine having a plurality of combustion chambers, that selectively executes operational control of the internal combustion engine according to a first mode in which a ratio of a period during which the internal combustion engine is operated is relatively small, and operational control of the internal combustion engine according to a second mode in which the ratio of the period during which the internal combustion engine is operated is relatively large, the air-fuel ratio control apparatus comprising a controller that executes a target air-fuel ratio correction that corrects a target air-fuel ratio when a difference among air-fuel ratios in the combustion chambers exists or is greater than a predetermined difference, and sets an air-fuel ratio correction amount that is a correction amount for the target air-fuel ratio by the target air-fuel ratio correction according to whether operational control of the internal combustion engine according to the first mode is being executed or whether operational control of the internal combustion engine according to the second mode is being executed.

2. The air-fuel ratio control apparatus according to claim 1, wherein the controller sets the air-fuel ratio correction amount to a smaller value as a time elapsed after operation of the internal combustion engine starts becomes longer.

3. The air-fuel ratio control apparatus according to claim 2, wherein the controller sets the air-fuel ratio correction amount to a smaller value the higher a temperature of the internal combustion engine is.

4. The air-fuel ratio control apparatus according to claim 1, wherein the controller sets the air-fuel ratio correction amount to a smaller value the higher a temperature of the internal combustion engine is.

5. The air-fuel ratio control apparatus according to claim 1, wherein the hybrid power unit also includes a battery; and the controller selects the first mode when there is a request to give priority to consuming electric power stored in the battery over ensuring that there be at least a predetermined amount of electric power in the battery, and selects the second mode when there is a request to give priority to ensuring that there be at least the predetermined amount of electric power in the battery over consuming electric power stored in the battery.

6. The air-fuel ratio control apparatus according to claim 1, wherein the hybrid power unit also includes a battery; and the controller selects the first mode when an amount of electric power stored in the battery is equal to or greater than a predetermined amount, and selects the second mode when the amount of electric power stored in the battery is less than the predetermined amount.

7. The air-fuel ratio control apparatus according to claim 6, wherein the controller operates the internal combustion engine so as to ensure output power required of the hybrid power unit only when it is not possible to ensure the required output power by output power from the electric motor when the first mode is selected, and operates the internal combustion engine so as to generate electric power to be stored in the battery when the second mode is selected.

8. An air-fuel ratio control method of a hybrid power unit provided with an electric motor and an internal combustion engine having a plurality of combustion chambers, that selectively executes operational control of the internal combustion engine according to a first mode in which a ratio of a period during which the internal combustion engine is operated is relatively small, and operational control of the internal combustion engine according to a second mode in which the ratio of the period during which the internal combustion engine is operated is relatively large, the air-fuel ratio control method comprising:
executing a target air-fuel ratio correction that corrects a target air-fuel ratio when a difference among air-fuel ratios in the combustion chambers exists or is greater than a predetermined difference, and
setting an air-fuel ratio correction amount that is a correction amount for the target air-fuel ratio by the target air-fuel ratio correction according to whether operational control of the internal combustion engine according to the first mode is being executed or whether operational control of the internal combustion engine according to the second mode is being executed.
